(19) United States
(12) Patent Application Publication
(10) Pub. No.: US 2014/0006182 A1
(43) Pub. Date: Jan. 2, 2014

(54) MEAL ORDERING SYSTEM AND METHOD

(71) Applicant: Naomi Wilson, Satellite Beach, FL (US)

(72) Inventor: Naomi Wilson, Satellite Beach, FL (US)

(21) Appl. No.: 13/931,545

(22) Filed: Jun. 28, 2013

Related U.S. Application Data
(60) Provisional application No. 61/665,844, filed on Jun. 28, 2012.

(51) Int. Cl. G06Q 50/12; G06Q 30/06

(52) U.S. Cl. CPC G06Q 50/12; G06Q 30/0635
USPC 705/15

(57) ABSTRACT

A system and method for utilizing a mobile device such as a cellular telephone or personal digital assistant to aid in the ordering of appetizers, drinks, entrées, desserts and other food items at a restaurant is disclosed in claimed. The system and method of the invention utilizes a user's mobile electronic device to capture order information and to bundle the order information into a graphic information code that may be scanned by a server's hand-held electronic device. Upon scanning, the free bundled order is displayed on the visual display of the server's mobile electronic device. The invention may be compatible with a restaurant's legacy ordering system and may be implemented with virtually no impact on a restaurant's pre-existing hardware or software. Alternate embodiments of the invention allow for identification of customers, delivery of customer loyalty and coupon information, delivery of menu selections and specials, and the like.

### CROSS REFERENCE TO RELATED APPLICATIONS

This nonprovisional patent application claims the benefit of provisional patent application Ser. No. 61/665,844, filed in the United States Patent and Trademark Office on Jun. 28, 2012, which is incorporated herein by reference in its entirety.

### STATEMENT REGARDING FEDERALLY SPONSORED RESEARCH OR DEVELOPMENT

Not applicable.

### INCORPORATION-BY-REFERENCE OF MATERIAL SUBMITTED ON A COMPACT DISK

Not applicable.

### BACKGROUND OF THE INVENTION

1. Field of the Invention

The invention relates generally to the field of systems and methods using electronic devices such as mobile, or mobile electronic devices, for example cellular telephones to facilitate the ordering of meals at, for example, restaurants. More specifically, the system and method of the invention enables a user to efficiently enter a restaurant order for a diner or a plurality of diners, bundling the order information electronically, and transmitting the bundled order to a food server or other receiver at a restaurant. Typical uses include, but are not limited to, restaurant ordering systems and the like. The system and method of the invention greatly reduces the time required for a user to place an order at the restaurant. Errors in order taking are also reduced.

2. Background Art

Typically, the ordering of meals in restaurants is done to great extent by hand. Restaurant servers approach patrons, ask for their food and drink selections, and either write their selection down on ordering pads which are designed for this purpose or alternatively may enter their meal selections into an electronic device that transmits the order selections to the kitchen. Such systems require that the patron wait in line for a seat, engage a hostess to lead them to their seat, wait for an available server to take their order, verbally place their order to the server, and wait while the server transcribes the order either onto a paper pad or electronic device. In some instances, wait periods of up to one hour may be experienced by patrons of a restaurant, depending upon the amount of patron traffic the restaurant is experiencing when patrons arrive. Thus the total time from arrival at the restaurant to delivery of a meal may require a patron to wait for well over an hour, and sometimes as long as two hours or even more, depending upon a number of variables.

Systems and methods for food ordering have been recently developed which utilize mobile electronic devices which are in electrical communication with a data server that is local to the restaurant to inquire as to table availability and to place meal orders in advance of the patron's arrival at the restaurant. For example, the system and method for managing restaurant customers and placing orders described in U.S. Pat. No. 8,089,346 describes a system comprising a local data server associated with a restaurant and mobile devices associated with the local data server that facilitate a customer of the restaurant to place orders. The system of U.S. Pat. No. 8,089,346 further comprises an Internet based application capable of sending data to the local data server and receiving data from the local data server, and still further comprises an alternate embodiment containing a magnetic card reader that facilitates the customer to make payment using their magnetic card, such as a credit card. The system described in U.S. Pat. No. 8,089,346 may further allow a customer of the restaurant to ascertain whether or not a table is available at the restaurant, or, alternatively, reserve a table at the restaurant for a given date and time. The system and method of U.S. Pat. No. 8,089,346 require custom electronic devices comprising magnetic card readers, custom software which is described as an application which may be an Internet based application, and at least a local data server which is, preferably, located at the restaurant. These elements require custom hardware and software development and require that a restaurant which desires to utilize the system must install, operate and maintain the local data server and Internet based application, and may also be required to maintain and control the mobile electronic devices which are elements of the system of U.S. Pat. No. 8,089,346. For this reason the cost of implementing and maintaining such a system as described in U.S. Pat. No. 8,089,346 may well exceed the ability of many restaurants.

Another system of the prior art is described in United States patent application publication US2002/0138350, which describes a system and method for transmitting stored user selections from a restaurant menu application on a mobile computer and then transmitting the user's food and drink selections to a terminal at a drive-through lane or walk-up ordering area at a restaurant. Using a menu application on a mobile computer, a customer can record menu selections that he/she wishes to order during the next visit to a restaurant. These menu selections can then be saved as a file in the memory on the mobile computer. When the customer later arrives at the restaurant, he/she can select the file with the previously recorded menu selections and beam (transmit) it to a station adjacent to the drive-through lane, without having to get out of the car, or to a station at a walk-up ordering area. When received by the station, the order can then be automatically transmitted to a computer terminal or printer within the restaurant, where restaurant employees can fulfill the order. However, the system and method of United States patent application publication US2002/0138350 comprises custom software and possibly custom hardware development for the restaurant in order to display the customer's order. A custom menu software application must also be installed on the user's mobile computer. A further limitation of the system and method of United States patent application publication US2002/0138350 is that the customer's order is generated by utilizing a menu that is stored on the user's mobile computer.

Another system of the prior art is described in United States patent application publication US2003/0158790, which describes a system for placing and executing electronic commercial transactions via the Internet. A customer transmits a transaction code to a vendor. The transaction code is a URL that includes the vendor's Internet address, and parameters associated with a preconfigured commercial transaction. Transaction codes can be stored by the customer's computer as icons, and/or web browser bookmarks. The transaction code is received by the vendor, and the desired preconfigured commercial transaction is identified. The identified transaction is then automatically executed. The vendor may request order verification or entry of an authorization password prior to executing the order. The system described in United States patent application publication US2003/0158790 suffers from the same shortcomings as the other systems of the prior art in that it requires a high degree of custom software to be developed, deployed and integrated into a particular vendor's ordering and purchasing system.

A significant roadblock to the implementation of the systems of the prior art is that they require a substantial level of integration with a particular restaurant's ordering system. Furthermore, as relates to restaurant chains, the rollout of such complex and integrated systems represents significant training, integration, and other challenges.

What is needed therefore is a low cost system and method utilizing existing technologies already in place with both the customer and the restaurants, which facilitates the placing of orders, reduces the time required to place an order and therefore results in increased efficiencies in the order taking process which heretofore has typically been by hand. The system and method of the present invention overcomes the shortcomings of the prior art by utilizing a customer's existing cellular telephone or other mobile electronic device and, in a preferred embodiment, utilizing a server's cellular telephone or other electronic device. The preferred environment of the system and method of the present invention require no custom hardware, data server, custom software, or other expensive elements to be purchased, developed or deployed by the restaurant. Alternate embodiments of the system and method of the present invention may comprise custom elements at the option of the user.

### BRIEF SUMMARY OF THE INVENTION

The present invention comprises a system and/or method that have one or more of the following features and/or steps, which alone or in any combination may comprise patentable subject matter. While the following description describes the use of the system and method of the invention in relation to restaurants, is to be understood that the system and method of the invention may also be utilized across any retail platform such as retail stores or the like. It is therefore the utilization of the invention in relation to restaurants is not to be construed as a limitation of the system and method of the invention.

In accordance with one of the simplest embodiments of the present invention, the invention, a user, such as a patron of a restaurant, utilizes a mobile electronic device such as a personal digital assistant, cell phone, electronic tablet, or any other mobile electronic device to enter meal ordering information in advance of arriving at a restaurant. The user may enter meal information for any number of patrons: for instance, there may be a party of four individuals intending to dine at a particular restaurant. In this case, the user may enter meal orders for all four individuals into the user's mobile electronic device where this order information is stored in memory. In this manner the user creates a list of meal selections to be presented to a restaurant server for ordering upon arrival and seating at the restaurant. The meal orders are stored electronically on the user's mobile device and, once the order is completed, alternatively may be transmitted to a remote data server via the Internet.

In a preferred embodiment of the invention the user's mobile electronic device generates an information code in the form of a scannable symbol such as a barcode or QR code which may be displayed on the visual display of the user's mobile electronic device. Upon arrival at the restaurant the user may inform the server that the party's order has already been entered and is available for scanning on the user's mobile electronic device visual display. The server may then use their own cellular telephone, PDA or other device to scan the information code, at which time the party's order will be downloaded automatically via the Internet and the party's order will be displayed upon the server's hand-held device. The server may then manually enter the order into the restaurant's legacy ordering system.

Numerous alternate environments described herein include such features as delivery of customer loyalty and coupon perks to the user, automatic display of the order in the kitchen by stepping the staff of manual entry of the order by the server, method for identifying the user's cellular telephone or other electronic device information for marketing and data mining purposes, and the like. Geo-location, food and drink ordering habits, favorite menu selections, party size, dates and times of arrival at a restaurant, identification of restaurants visited, demographic information and other information may be collected, retained and analyzed by the system and method of the invention. Such information may have commercial value and may therefore be a significant component of the business model employed by the provider of the system.

### BRIEF DESCRIPTION OF THE DRAWINGS

The accompanying drawings, which are incorporated into and form a part of the specification, illustrate one or more embodiments of the present invention and, together with the description, serve to explain the principles of the invention. The drawings are only for the purpose of illustrating the preferred embodiments of the invention and are not to be construed as limiting the invention. In the drawings:

FIG. 1 depicts an exemplary flowchart for the initial steps of the system and method for a basic embodiment of the invention.

FIG. 2 depicts an exemplary flowchart for the user's recording of a restaurant order using the system and method of the invention.

FIG. 3 depicts the physical elements of a mobile electronic device which is used in the system and method of the invention.

FIG. 4 depicts a restaurant server scanning a user's graphic information code in order to retrieve the user's order information from the system and method of the invention.

FIG. 5 depicts an exemplary screen shot of an embodiment of the invention that allows for scanning a restaurant's restaurant identifier graphic symbol.

FIG. 6 depicts an exemplary screen shot of an embodiment of the invention, showing one embodiment of a screen for selecting a person for whom meal order information may be entered.

FIG. 7 depicts an exemplary screen shot of an embodiment of the invention in which meal order information for a particular person, who may be part of a larger party of persons, may be entered into a user mobile electronic device.

FIG. 8 depicts an exemplary screen shot of an embodiment of the invention in which meal order information may be entered into a user mobile electronic device free style.

FIG. 9 depicts an exemplary screen shot of an embodiment of the invention in which meal order information may be entered into a user mobile electronic device by selecting from a menu.

FIG. 10 depicts an exemplary screen shot of an embodiment of the invention in which menu item price, description and dietary or nutritional information may be presented to a user by displaying on the visual display of a user mobile electronic device.

FIG. 11 depicts an exemplary screen shot of an embodiment of the invention in which a graphic information symbol is displayed on the visual display of a user mobile electronic device.

FIG. 12 depicts an exemplary screen shot of an embodiment of the invention in which a bundled graphic information symbol containing payment information is displayed on the visual display of a user mobile electronic device and wherein a user may make enter a tip amount and make payment for a bill.

FIG. 13 depicts an exemplary screen shot of an embodiment of the invention in which successful payment may be confirmed to a user, and wherein a user may provide rating information regarding the restaurant.

### DETAILED DESCRIPTION OF THE INVENTION

The following documentation provides a detailed description of the invention.

In this disclosure the terms of mobile device, cellular telephone, personal digital assistant, and mobile electronic device are interchangeable and refer to a device which comprises the capability to scan a graphic code such as a QR code, barcode or the like; the capability to communicate with a remote server such as over the cellular telephone network, internet, wireless networks such as WiFi or Bluetooth or the like; the capability to be carried by the user; the capability to execute a sequential series of steps such as those identified in this disclosure; and the capability to display information on a visual display. Preferably, the mobile electronic device is further comprised of a memory which is adapted to store instructions such as software instructions for carrying out the system and method of the invention. In some of the additional alternate embodiments of the system and method of the invention and mobile device may further comprise the capability of reading radiofrequency ID (RFID) tags. Such mobile devices are currently known in the electronic arts and are typically comprised of microprocessors, memory for the storage of data and program instructions, and input and output devices such as screens, visual displays, touch screens, voice recognition functions and keypads. The physical implementation of the functional features of the mobile device of the system and method of the invention are not to be construed as limitations to the present invention.

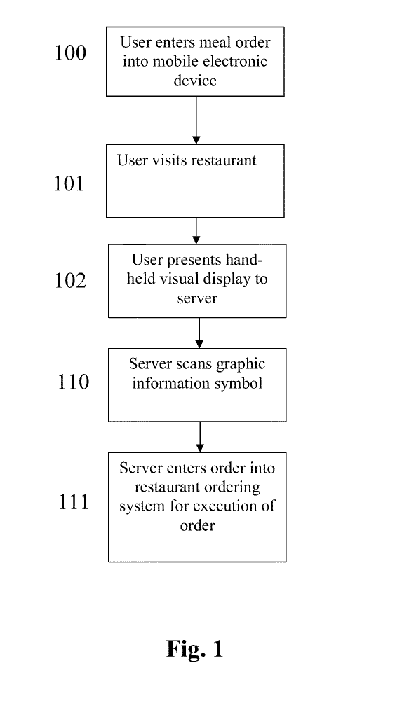

Referring now to FIG. 1, a user of the system and method of the invention desires to record a meal order for communication to a restaurant server upon arrival at a restaurant of the user's choice. The user records the order using a mobile electronic device such as a cellular telephone, a PDA, or any other device having the features and elements described herein 100. The user may record orders for a single person, or may likewise record orders for a plurality of persons such as in a party of individuals. The orders may be input to the user's mobile electronic device by any of the methods known in the art such as, but not limited to, keypad entry, touch screen entry, downloading from another electronic devices, voice recognition, and the like. Once the order has been entered, a graphic information symbol is produced and stored in user's mobile electronic device. The number of persons placing orders using the system and method of the invention is not to be construed as a limitation. Next, the user and the members of the user's party, if any, visit the restaurant 101. After being seated, the user presents his or her mobile electronic device to the server 102. The graphic information symbol, such as a QR code or barcode is displayed on the visual display of the user's mobile electronic device. The restaurant server may then scan the graphic information symbol which is displayed upon the user's mobile electronic device 110. After scanning, the restaurant server's hand-held electronic device automatically downloads the meal order details of the bundled order and presents those details upon the restaurant server's hand-held electronic device's visual display. The restaurant server may then enter the order in the usual manner using the restaurant's pre-existing ordering system 111.

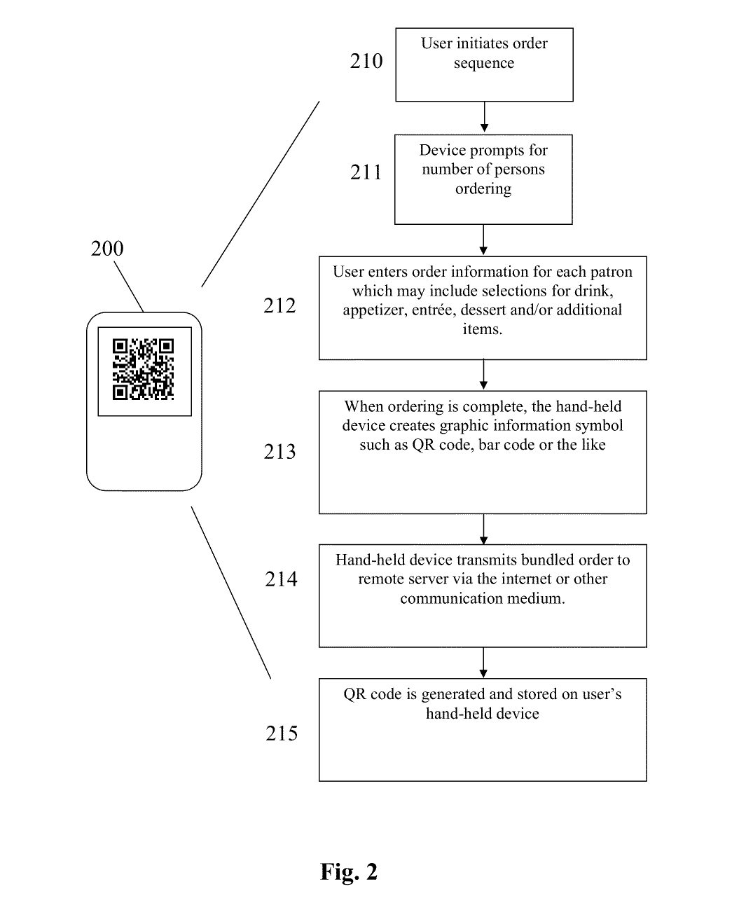

Referring now to FIG. 2, a more detailed view of a preferred embodiment of the sequence of steps taken by the user when placing the order is depicted. When the user and the user's party desire to place an order they initiate the order sequence on the user's mobile electronic device. The order sequence is contained as a series of instructions which are stored in the memory of the user's mobile electronic device. After initialization of the order sequence 210, the application residing upon the user's mobile electronic device prompts the user to enter the number of persons in the user's party 211. The user enters the number of persons in his or her party by using any of the known techniques for entering data into a mobile electronic device which may include using the keyboard, a touchscreen, speech recognition, or any other means known in the art for entering information into a mobile electronic device 212. The user enters order information as prompted by the instructions contained in the mobile electronic device's memory. The information prompted may include identity of each person in the party, their selection for drink, their selection for appetizer, their selection for entrée, their selection for desserts, and any other order they wish to make. The specific information prompted by the system and method of the invention may take any form the system provider desires. The system and method of the invention are not to be construed as being limited by the exemplary types of information presented herein.

Still referring to FIG. 2, the user continues to enter order information for each member of the party as prompted by the system and method of the invention until the order is completed. Once the order is complete the user's mobile electronic device 200 may create a graphic information symbol such as a QR code, barcode or the like which contains data describing the user's order information 215. The graphic information symbol 213 is stored in the user's mobile electronic device memory for later display to the restaurant server upon arrival at the restaurant. The graphic information symbol may alternatively be generated by a remote server. In this alternate embodiment of the invention, a remote server is accessed by the user's mobile electronic device 200 and the data regarding the user's order information is uploaded to a remote server 214 via the internet or any other means known in the art. The remote server may comprise a communication capability, a processing capability, and a memory capability. The remote server may store the data regarding the user's order information so that it can be accessed from any other location which is in communication with the Internet, for instance, a server's hand-held electronic device or another computing device. In this manner, data regarding the user's order information may be accessed from anywhere on the World Wide Web by anyone scanning the specific graphic information symbol which was generated for that user's specific order.

It can be seen and appreciated that the system and method of the invention does not require modification of the restaurant's legacy order entry systems. Thus the time required for the taking of a restaurant order is greatly reduced without the need for any modification of the retail restaurant's systems.

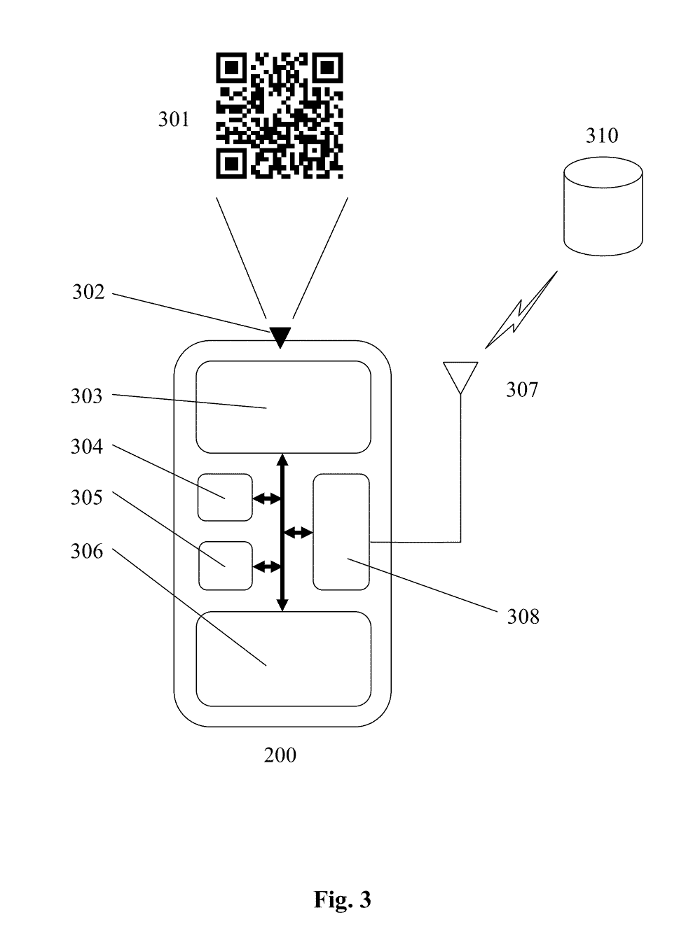

Referring now to FIG. 3, the physical elements of a preferred embodiment of the hand-held or mobile electronic devices 200 of the system of the invention are depicted. Hand-held or mobile electronic device 200 may comprise a processor for the execution of the steps of the system and method of the invention 304, a memory for storage instructions relating to the steps of the invention 305, a visual display 303, wireless interface transceiver 308 and antenna 307, scanning element 302 for the reading of product information 301 and manual input device 306 which may be, for example, a keyboard or a soft keyboard such as those used on touch screen devices. Each of the elements of hand-held or mobile electronic device 200 are in electrical communication with one another either directly or indirectly. Hand-held or mobile electronic device 200 communicates with remote server 310 via any of the known methods and communications channels known in the art: for example, the cellular telephone network, Wi-Fi, Bluetooth, infrared communications ports or any other communication channel and method. The particular communication channel and method may be of any type known in the art and is therefore not a limitation of the system and method of the invention.

A preferred embodiment of the system and method of the invention utilizes a graphic symbol such as, for example, a QR code to bundle the meal order information. A QR code (short for “Quick Response”) is a type of graphic code that, upon scanning, may be decoded for specific information contained within the code itself The information contained within the QR code may comprise instructions directing the processor of a Web-enabled device to immediately follow a link to location on the World Wide Web which contains information desired to be provided to a user. Alternatively, the QR code may contain the complete information about the food order so that no link to the internet or World Wide Web is required for the restaurant server to ascertain the details of the user's order. In this disclosure, the term graphic information symbol is intended to include QR codes, bar codes or any other graphic symbol which contains information which can be understood by scanning using a hand-held, mobile, kiosk or any electronic device with optical scanning capability.

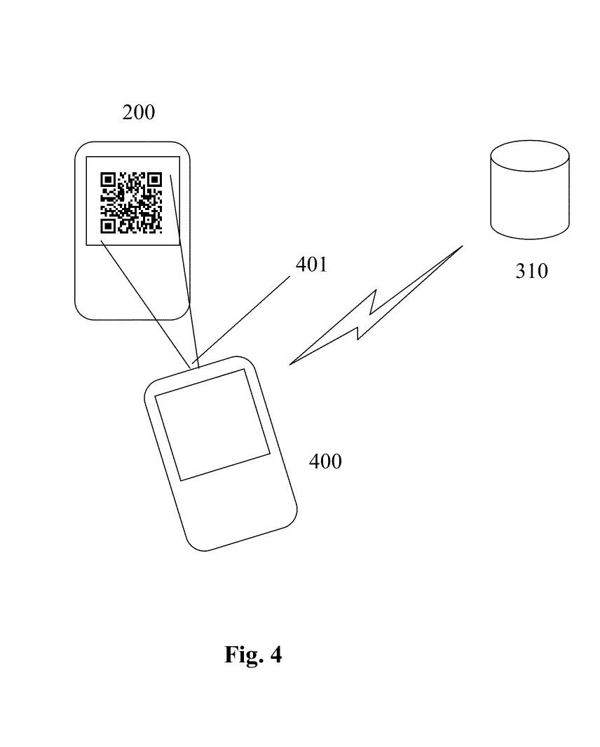

Referring now to FIG. 4, a restaurant server may utilize a server hand-held electronic device 400 to scan 401 the graphic information symbol displayed upon the users mobile electronic device 200. In a preferred embodiment of the system and method of the invention the scanned 401 graphic information symbol may be decoded by the restaurant server's hand-held mobile electronic device 400, and the user's order information displayed upon the visual display of the restaurant server's hand-held mobile electronic device 400. The restaurant server may then proceed directly to entering the user's order information into the restaurant's pre-existing order taking system. In this manner the time required to sequentially poll each user in a party to take their orders into handwriting orders on to an order taking tablets or to enter their orders into a separate electronic device is eliminated. Also, the error rate of taking food orders is greatly reduced. An alternate embodiment of the system and method of the invention comprises the steps of communication by the restaurant server's electronic hand-held device 400 with remote server 310. In this alternate embodiment the graphic information symbol displayed upon the user's mobile electronic device 200 contains instructions for directing the restaurant server's hand-held mobile electronic device 400 to an address located on remote server 310 where the user's order information is stored. Such direction may be, for example, by way of a Uniform Resource Locator (URL) or equivalent. Upon accessing by the restaurant server's hand-held mobile electronic device 400 after scanning 401 the graphic information symbol, remote server 310 downloads the user's order information to the restaurant server's hand-held mobile electronic device 400 where it is displayed upon the server's hand-held mobile electronic device's 400 visual display. The server may then enter the user's order information into the pre-existing order taking system employed by the restaurant. The specific order entry system used by the restaurant is not to be considered a limitation in the system and method of the invention.

In yet a further alternate embodiment of the system the system and method of the invention, information regarding the identity of the user, the identification of the specific selections ordered by the user, and like information may be stored on remote server 310 for later access by the restaurant, the user, or a third-party. In this way a database of valuable information may be created by the system implementer. This database of information may be exploited for commercial purposes such as demographic information regarding patrons, geographic location regarding patron location, the number of times patrons visit a particular establishment, the types of food ordered by particular types of patrons and statistical data regarding the most likely and least likely order to be made by such individuals, and all manner of information that may be useful in determining the most efficient means for advertising to specific groups of individuals. This information may be useful, for instance, in establishing customer loyalty, advertising and coupon campaigns directed to specific individuals or groups of individuals.

In a still further environment of the system and method of the invention, restaurants may provide menus or other information to the system provider enabling the system provider to provide such information to a user's mobile electronic device 200 in order to facilitate the user's ordering process. Such information may include, for example, the restaurant's menu. In this manner a restaurant may insure that the items ordered by a user are bona fide menu items, thus reducing confusion in the ordering process. The system may also allow restaurants to update their menu selections in real-time so that users of the system would immediately know if certain menu items are not available at the time the user desires to visit the restaurant. In this alternate embodiment of the system and method of the invention, instructions contained in the user's mobile electronic device 200 may display menu selections provided by the restaurant. These menu selections may be stored on remote server 310 and downloaded to a user's mobile electronic device 200 when the user initiates the ordering process. The instructions contained in the user's mobile electronic device 200 may limit the selections available to the user to only those elections which are currently available at the restaurant. The system and method of the invention may also use this same process to provide information regarding specials which may only run during certain days or during certain times. Such specials information may be uploaded to the remote server 310 where the information is stored. Upon initiation of the order entering process by a user of the system and method of the invention, the specials information may be downloaded to the user's mobile electronic device 200 where it is displayed. In like manner, advertisements may be displayed for upcoming events, upcoming specials, and the like.

In a still further embodiment of the system and method of invention, wait times may be provided to the user and table reservation orders may be taken. In this embodiment of the system and method of the invention, the restaurant uploads to server 310 information regarding wait times. This time sensitive information may persist on the server 310 only for limited time as determined by the restaurant. Upon initiation of the order entry process by a user, server 310 may download wait time information to the user's mobile electronic device 200 whereupon wait time information is displayed. In this manner a user may determine an optimum time to arrive at the restaurant in order to minimize delay. Alternatively, the system and method of the invention may be used to allow a user to upload an expected time of arrival at the restaurant and to reserve a table, if the restaurant allows patrons to do so. In this alternate embodiment, the user enters along with order information and expected arrival time of the restaurant. This table reservation information, which may include the number of patrons in the party, the expected time of arrival, and the meal order information for the patrons may be uploaded by the user's mobile electronic device 200 to remote server 310 where it is transmitted to the restaurant by any means or electronic communication and in the arts such as text messaging, e-mail, display on a web page or the like. The restaurant may then decide to hold a table for the patron. The system and method of the invention may also be utilized to provide customer loyalty rewards. For instance, patrons to spend above a certain limit or to visit the restaurant above a certain frequency may be allowed to reserve tables using the system and method of the invention with preference, or with some special offer or perk.

In a still further embodiment of the system and method of the invention a restaurant may provide a scanning capability which scans the user's graphic information symbol such as, scanning 401 at a kiosk, and thereby eliminating the step of manual entry of the user's order information by the restaurant server into the system's pre-existing order taking system. Such scanning 401 of the user's graphic information symbol may be by direct scanning 401 of the users visual display on the user's mobile electronic device 200, or may be by scanning a copy of the user's graphic information symbol displayed upon the server's hand-held mobile electronic device 400 and presented to the scanning 401 capability at the kiosk. In a still further embodiment of the system and method of the invention, the scanning 401 capability may be adapted to be present at the tableside, so that user themselves may initiate a scan process whereupon the user's order information may be transmitted directly to the restaurant's kitchen.

In a still further embodiment of the system and method of the invention, the user's mobile electronic device 200 may further comprise a GPS receiver. GPS receivers typically provide geo-location information regarding the location of the user at any given time. Many hand-held or mobile electronic devices 400 such as smart phones, tablets, cellular telephones, PDAs, laptop computers and the like comprise GPS receivers. In this alternate embodiment, the system and method of the invention may further comprise instructions which utilize the GPS location information relative to the user to identify special deals or loyalty rewards offered by the restaurant. In this environment, the system and method of the invention identifies the restaurant at which the user is located, searches its own database for offers or other special deals such as loyalty rewards which the restaurant desires to offer to the user, and transmits a message from remote data server 310 to the user's mobile electronic device 200 whereupon the message is displayed on the visual display of the user's mobile electronic device 200. The message may include any message desired by the restaurant.

In a preferred embodiment of the system and method of the invention, the system provider provides remote server 310, instructions for carrying out the system and method of the invention which are located in the memory of remote server 310, and a software application which resides in memory of the user's mobile electronic device 200. The user simply downloads the application into the mobile electronic device's 200 memory by any of techniques and methods commonly known in the art for downloading applications and other software to a mobile electronic device 200. Such applications are typically downloaded from web sites or other Internet locations. In a preferred environment of the system and method of the invention, the system provider makes the application available for download by the user by any means then in the art, but typically by download through the Internet. In this manner the software application containing instructions to carry out the system and method of the invention is downloaded to the user's mobile electronic device 200.

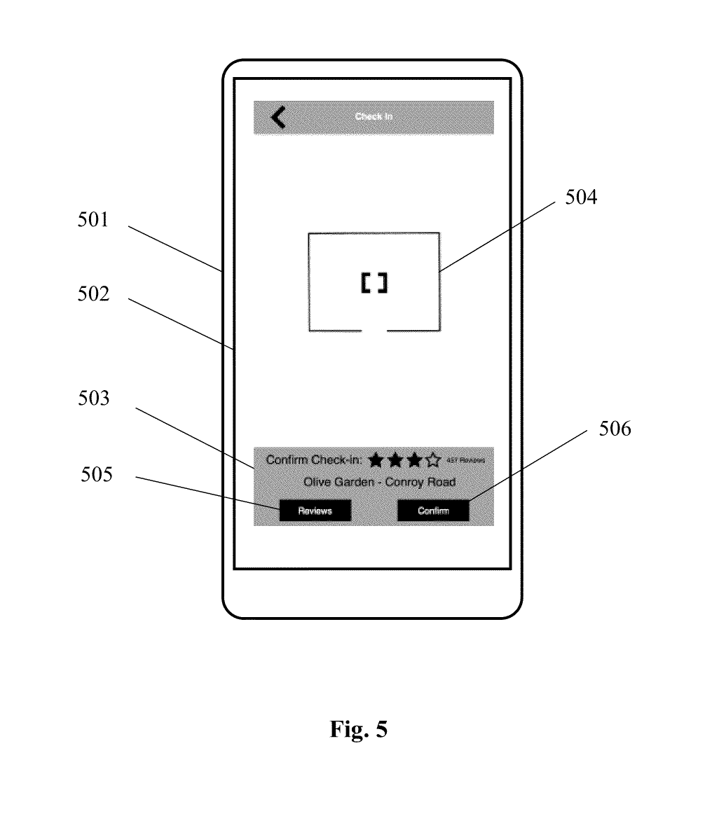

In a still further alternate embodiment of the invention depicted in the exemplary screen shot FIG. 5, a restaurant may employ a QR or other code as a restaurant identifier graphic symbol, and may display the restaurant identifier in a prominent place in the restaurant, at tables in the restaurant, advertisement such as magazines or marketing publications, or on the restaurant's web site or mobile site. A user may use their mobile electronic device 501 to scan the restaurant identifier graphic symbol. The optical scanning feature of mobile electronic device 501 causes an image of the scanned restaurant identifier graphic symbol 504 to appear on visual display 502. Upon scanning the restaurant identifier graphic symbol, the user's mobile electronic device 501 may navigate to the remote server by, for example, use of a web browser resident on mobile electronic device 501 which follows a world wide web link to the remote server embedded in the restaurant identifier graphic symbol, whereupon the remote server receives identifies the specific restaurant that is associated with the restaurant identifier graphic symbol. The remote server then may communicate certain restaurant specific information to the user's mobile electronic device 501 such as, for example, restaurant location, name of restaurant, available menu selections, available loyalty rewards, identification of special menu items, identification of popular items and the like whereupon mobile electronic device 501 may display certain information about the restaurant on the visual display 502. The invention may also display button 505, which, upon selection, may display reviews concerning the restaurant from online or other review services, and may also display restaurant address, identification, and star rating in window 503. Then invention may also display button 506 which, when selected, identifies that the restaurant identified in window 503 is indeed the restaurant of interest to the user.

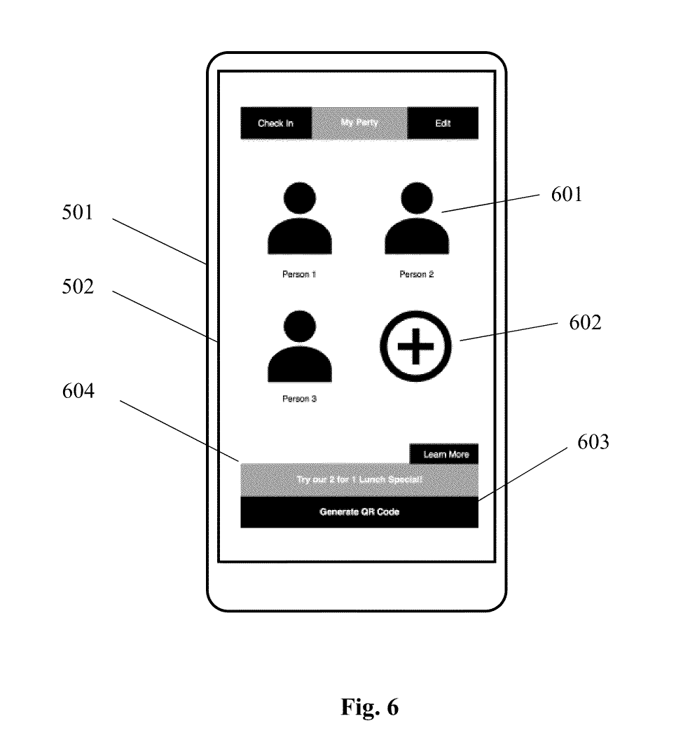

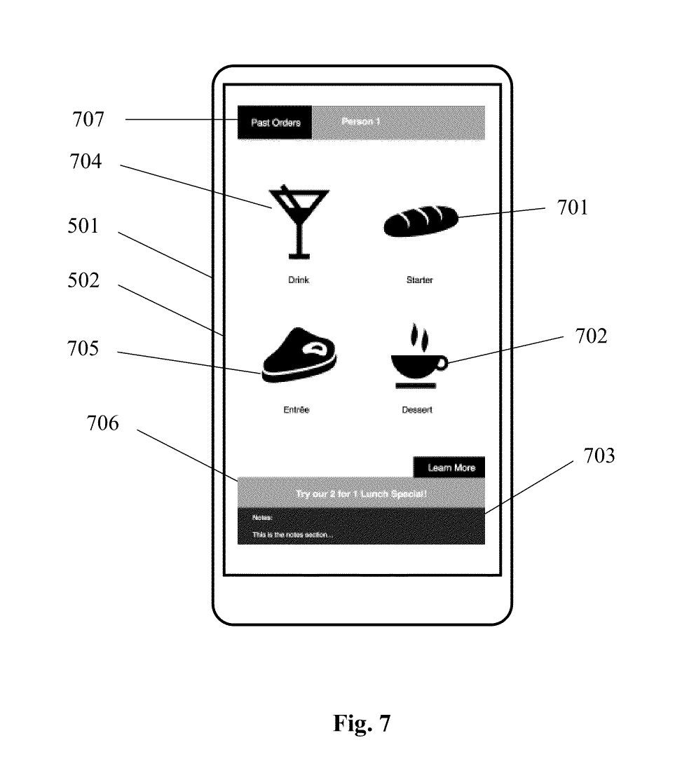

In the exemplary screen shot of an embodiment of the invention depicted in FIG. 6, a first ordering screen display is depicted. Patrons are identified by icons as “Person 1” 601, “Person 2”, “Person 3” and so on. The nomenclature used to identify a patron in the party is not to be construed as limiting; any appropriate nomenclature that differentiates between party patrons may be implemented in the invention. A user may select any party patron by selecting their icon such as, for the example shown in FIG. 6, Person 2 601, whereupon the invention navigates the user to a screen such as the screen shown in FIG. 7 and described below that allows meal order information for that person to be entered into the mobile electronic device 501. Once all the meal order information for all patrons has been entered into mobile electronic device 501, a graphic information symbol, which may be, by way of example and not of limitation, a QR code, may be generated by selecting Generate QR Code button 603. Upon selection of this button, the graphic information symbol may be generated and associated with the meal order information that has been entered for the party. Further, special offers may be advertised by the restaurant to the patrons when a user selects button 604. Upon selecting button 604, special offers may be displayed upon visual display 502 of mobile electronic device 501 for review by the user.

Referring now to FIG. 7, an exemplary screen which allows a user to enter meal order information is depicted. Once the person is selected as discussed and shown in FIG. 6, the invention may display a meal order information screen on visual display 502 of mobile electronic device 501 such as the exemplary screen shown in FIG. 7. This screen may allow the user to select icons that allow further selection of menu items in categories such as, for example and not by way of limitation, drinks 704, starters or appetizers 701, entrees 705, desserts 702, and so on. Once a category has been selected, the invention may display a screen presenting meal options in the selected categories to the user such that the user may select specific meal options. The invention may also allow the user to input notes through a manual input device such as a keyboard by selecting button 703. Such notes may include information helpful or useful to the server such as food allergies or special preparation orders. The invention may also comprise button 707 which, when selected, may display past or favorite orders from previous trips to the restaurant, allowing the user to be reminded of orders they may wish to repeat or avoid. Further, special offers may be advertised by the restaurant to the patrons when a user selects button 706. Upon selecting button 706, special offers may be displayed upon visual display 502 of mobile electronic device 501 for review by the user.

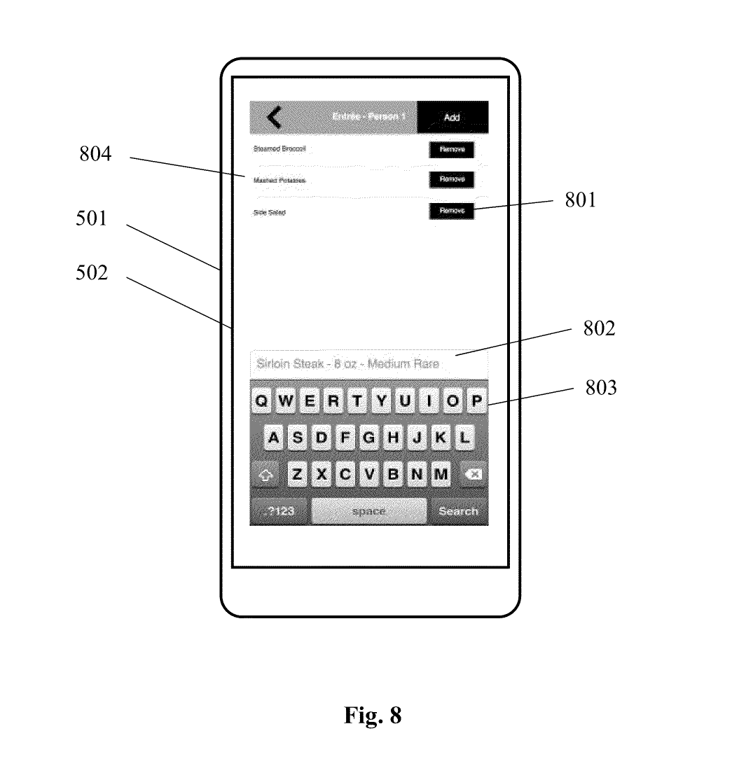

Referring now to FIG. 8, an exemplary screen of an embodiment of the invention which allows a user to add items freeform, that is, without making selections from a predetermined list of available items, is depicted. A user may use a manual input device such as voice recognition or a keyboard 803 to enter desired meal information. A list of desired meal choices 804 may then be displayed on visual display 502 of mobile electronic device 501. Specific meal choice entries may be deleted by selecting button 801 or similar button. A plurality of buttons 801 may be displayed in which each meal choice has an associated button 801 that, when selected, removes that meal choice from the list of meal choices. As a meal choice is entered through the manual input device 803, which may be a keyboard, the characters entered into the electronic mobile device 501 may be displayed in window 802.

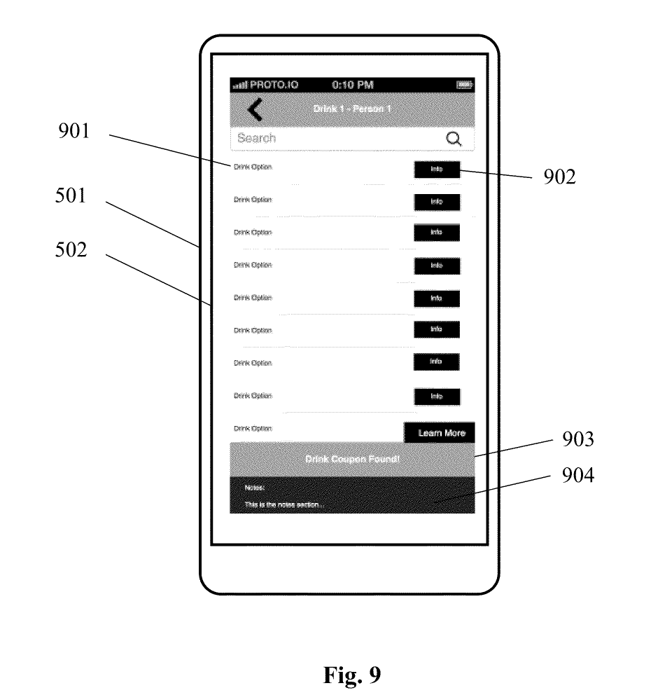

Referring now to FIG. 9, an exemplary screen shot of an alternate embodiment of the invention is depicted, in which available menu items are displayed on visual display 502 of mobile electronic device 501. In this embodiment of the invention, a restaurant has communicated available menu items to the remote server using any communication means known in the art including, but not limited to, using the internet to navigate to a world wide web address for the remote server whereupon the remote server stores the available menu options. Upon scanning a restaurant's restaurant identifier graphic symbol, a user's mobile electronic device 501 may navigate to the remote server's world wide web address using internet as is known in the art, and the restaurant's available menu options may be communicated from the remote server to the user's mobile electronic device 501. The available menu items 901 may be displayed upon visual display 502 for selection by the user. Additional information about the available menu items may be reviewed when the user selects button 902. Such information may include further description, methods in which the menu item may be prepared, nutrition metrics such as sodium content, fat content, calories, and other information that may be of importance to the user in making a menu item selection. The invention may present button 903 to the user, which may indicate that coupons are available for the available menu items. The invention may also allow the user to input notes through a manual input device such as a keyboard by selecting button 904. Such notes may include information helpful or useful to the server such as food allergies or special preparation orders.

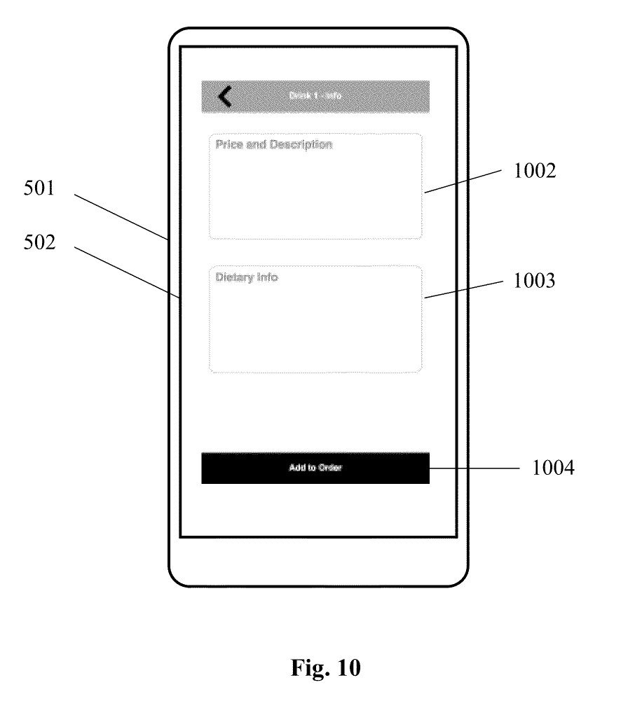

Referring now to FIG. 10, an exemplary screen shot of an alternate embodiment of the invention is depicted, in which menu item price, description and dietary or nutritional information for a particular menu item may be displayed on visual display 502 of mobile electronic device 501. In the example shown, menu item price and description may be displayed in window 1002, while dietary or nutritional information may be displayed in window 1003. A user may elect to add the menu item to a meal order by selecting button 1004. Pricing information, description, dietary and nutritional information for a particular menu item may be communicated from the remote server to the user's mobile electronic device 501 at any time. As an example, pricing information, description, dietary and nutritional information for a particular menu item may be communicated from the remote server to the user's mobile electronic device 501 upon the scanning of a restaurant identifier graphic symbol for a particular restaurant. As described elsewhere herein, the scanning of a restaurant identifier graphic symbol for a particular restaurant may initiate a communication sequence between the remote server and the mobile electronic device 501 which may include pricing information, description, dietary and nutritional information for menu items that have been communicated to the remote server by the restaurant using any of the known methods for communication with a remote server, but in a preferred embodiment, is by use of accessing the world wide web address of the remote server over the internet.

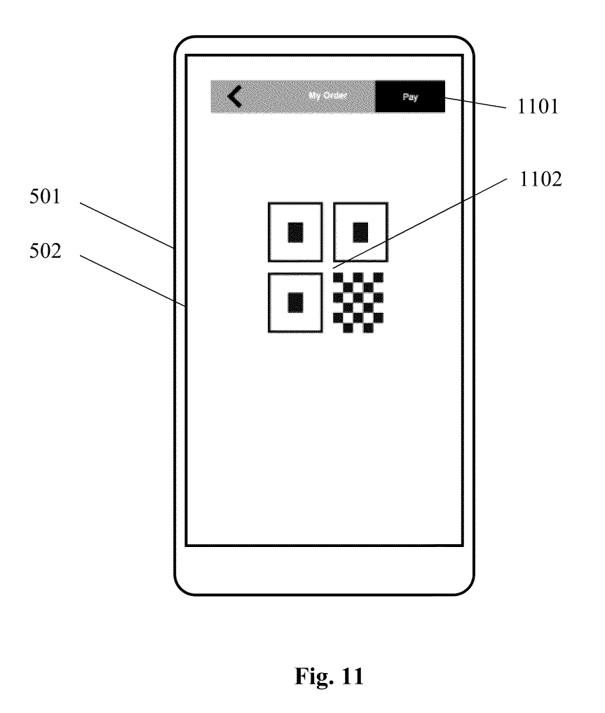

Referring now to FIG. 11, an exemplary screen shot of an alternate embodiment of the invention is depicted, in which a meal order has been bundled along with a graphic information symbol, such as, for example and not by way of limitation, a QR code 1102. The graphic information symbol may be displayed on visual display 502 of mobile electronic device 501. The invention may also comprise button 1101 which may be selected by a user to initiate a payment sequence which may consist of the steps of confirmation and presentation of final amount owed, entering of a user's payment information such as credit card, debit card, digital wallet or other payment account information into mobile electronic device 501, transmission of the user's payment information to the remote server via the internet and transmission of the user's payment information to the restaurant via the internet or other communication means. The restaurant may then deduct payment from the user's financial account and may provide confirmation to the user via any communication means known in the art such as text messaging, email messaging, by sending paper receipt to the user's address or by providing a paper receipt to the user at the time of payment, or by any other known means for confirming payment known in the art.

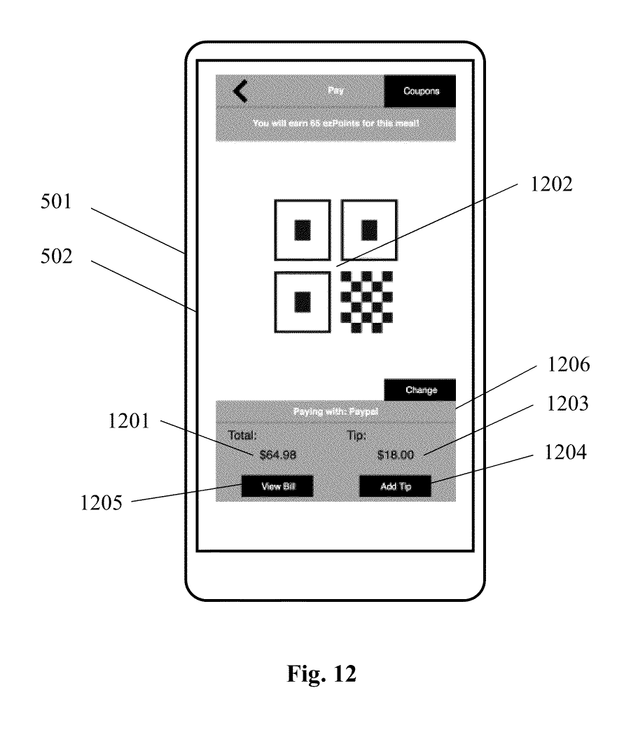

Referring now to FIG. 12, an exemplary screen shot of an alternate embodiment of the invention is depicted, in which graphic information symbol 1202, which by way of example and not limitation may be a QR code, is used to present the order for scanning by the restaurant server using a server hand-held electronic device. Graphic information symbol 1202 may also contain bill information, or it may contain a link to the remote server which has stored bill information. The total amount of the meal order 1201 may be displayed on visual display 502 of mobile electronic device 501 for presentation to the user. The user may select button 1205 to view an itemized listing of the final bill. The user may also select button 1204 to enter a tip for the server. Selecting button 1204 may cause a software keyboard to appear on visual display 501 which allows the user to manually input the amount of the tip. The user may also be presented with the option to specify a desired tip amount as a percentage of the total bill, whereupon the invention may calculate the tip based upon the amount of the total bill and the desired percentage. The tip amount that is either directly entered or is calculated by the invention may be displayed 1203 on visual display 502 of mobile electronic device 501. The identification of the account or financial service by which the user is making payment may be displayed in window 1206.

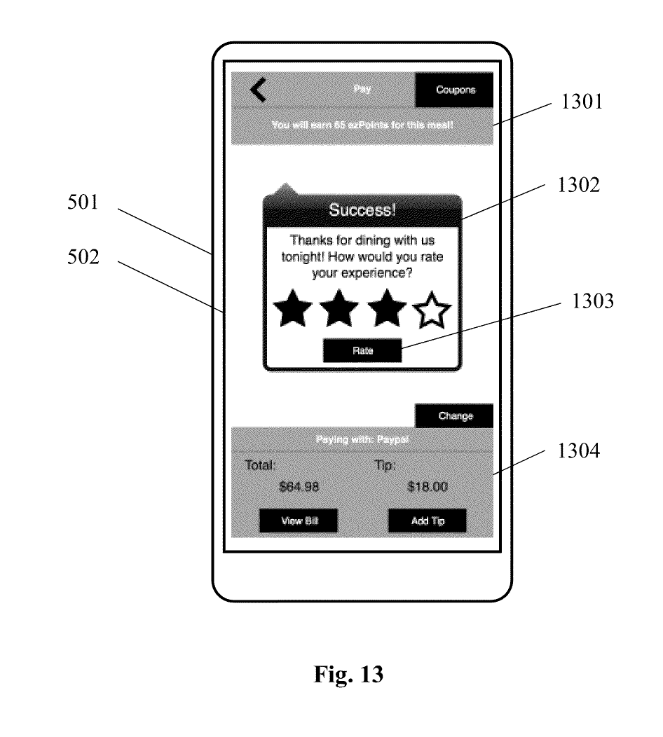

Referring now to FIG. 13, an exemplary screen shot of an alternate embodiment of the invention is depicted, in which the user has completed payment of the bill. A successful payment may be indicated by notification 1302 which also allows a user to provide a rating of the restaurant by selecting button 1303 whereupon the user may be prompted to enter rating information. Payment in formation such as total amount of bill, amount of tip and identification of the account or financial service by which the user is making payment may be displayed in window 1304.

It is to be understood that the screen shots depicted in the figures are exemplary, and the arrangement of graphics and use of specific graphic symbols and nomenclature as depicted are merely exemplary and that the scope of the claims include all variations of arrangement, screen layout, and design of graphic symbols. As such, the invention is not to be limited to only the specific screen layout and graphic symbols depicted in the drawings.

Although a detailed description as provided in the attachments contains many specifics for the purposes of illustration, anyone of ordinary skill in the art will appreciate that many variations and alterations to the following details are within the scope of the invention. Accordingly, the preferred embodiments of the invention are set forth without any loss of generality to, and without imposing limitations upon, the claimed invention. Thus the scope of the invention should be determined by the appended claims and their legal equivalents, and not merely by the preferred examples or embodiments given.

What is claimed is:

1. An improved meal ordering system, comprising:
at least one user mobile electronic device comprising a memory, a processor, an optical scanner, a manual input device, a wireless transceiver in communication with the world wide web, and a visual display, wherein said processor is in electrical communication with said memory, said manual input device and said visual display;
a remote server in wireless communication with said user mobile electronic device; and
a server hand-held electronic device comprising a memory, a processor, an optical scanner, a wireless transceiver in communication with the world wide web, and a visual display, wherein said processor is in electrical communication with said memory, said wireless transceiver and said visual display;
wherein said user mobile electronic device is adapted to perform the steps of receiving meal order information, storing said meal order information, generating a graphic information symbol associated with said meal order information, and communicating said meal order information and graphic information symbol to said remote server; and
wherein said remote server is adapted to perform the steps of decoding said graphic symbol, reading said associated meal order information, storing said meal order information, and communicating said meal order information to said server handheld electronic device when said server handheld electronic device scans said graphic symbol; and
wherein said server hand-held electronic device contains instructions to scan said graphic symbol when said graphic symbol is displayed on said visual display of said mobile electronic device, decode said graphic symbol, follow said embedded link to said world wide web address, download said meal order information associated with said graphic symbol, and display said meal order information on said server handheld electronic device visual display.

2. The meal ordering system of claim 1, wherein said graphic symbol is a QR code.

3. The improved meal ordering system of claim 1, wherein said mobile electronic device is further defined as being selected from the group consisting of a cellular telephone, an electronic tablet, and a personal digital assistant.

4. The improved meal ordering system of claim 2, wherein said mobile electronic device is further defined as being selected from the group consisting of a cellular telephone, an electronic tablet, and a personal digital assistant.

5. The meal ordering system of claim 1, wherein said remote server further contains instructions to receive information regarding the availability of menu items from a restaurant, and wherein said remote server communicates said information regarding availability of menu items to said user mobile electronic device such that a user of the invention may select only menu items which have been communicated to said remote server as available items for inclusion in said meal order information.

6. The meal ordering system of claim 2, wherein said remote server further contains instructions to receive information regarding the availability of menu items from a restaurant, and wherein said remote server communicates said information regarding availability of menu items to said user mobile electronic device such that a user of the invention may select only menu items which have been communicated to said remote server as available items for inclusion in said meal order information.

7. The meal ordering system of claim 3, wherein said remote server further contains instructions to receive information regarding the availability of menu items from a restaurant, and wherein said remote server communicates said information regarding availability of menu items to said user mobile electronic device such that a user of the invention may select only menu items which have been communicated to said remote server as available items for inclusion in said meal order information.

8. The meal ordering system of claim 4, wherein said remote server further contains instructions to receive information regarding the availability of menu items from a restaurant, and wherein said remote server communicates said information regarding availability of menu items to said user mobile electronic device such that a user of the invention may select only menu items which have been communicated to said remote server as available items for inclusion in said meal order information.

9. The meal ordering system of any of claims 1-8, wherein said remote server further contains instructions to receive information regarding table wait times from a restaurant, and wherein said remote server is further adapted to communicate said table wait time information to said mobile electronic device, and wherein said mobile electronic device is adapted to display said table wait time information on said visual display of said user mobile electronic device.

10. The meal ordering system of any of claims 1-8, wherein said mobile electronic device further contains instructions to receive table reservation information from a user and to communicate said table reservation information to said remote server, and wherein said remote server is adapted to communicate said table reservation information to a restaurant.

11. An improved meal ordering method comprising the steps of:
entering meal order information into a user mobile electronic device;
communicating said meal order information to a remote server on the world wide web;
storing said meal order information at an address on the world wide web;
associating a graphic symbol with said meal order information, wherein said graphic symbol contains an embedded link to an address on the world wide web where said meal order information is stored;
communicating said graphic symbol to said user mobile electronic device;
displaying said graphic symbol on a visual display of said mobile electronic device;
scanning said graphic symbol using a server hand-held electronic device while said graphic symbol is displayed on said visual display of said user mobile electronic device;
decoding said graphic symbol to retrieve the world wide web address embedded therein;
following said world wide web address and downloading said meal order information from said address; and
displaying said meal order information on a visual display of said server hand-held electronic device.

12. The improved meal ordering method of claim 11, wherein said graphic symbol is a QR code.

13. The improved meal ordering method of claim 11, wherein said user mobile electronic device is further defined as being selected from the group consisting of a cellular telephone, an electronic tablet, and a personal digital assistant.

14. The improved meal ordering method of claim 12, wherein said user mobile electronic device is further defined as being selected from the group consisting of a cellular telephone, an electronic tablet, and a personal digital assistant.

15. The improved meal ordering method of claim 11, further comprising the steps of communicating information regarding available menu items to said remote server, communicating said information regarding available menu items from said remote server to said user mobile electronic device, and limiting meal selections that may be made by a user to only those menu items that are available.

16. The improved meal ordering method of claim 12, further comprising the steps of communicating information regarding available menu items to said remote server, communicating said information regarding available menu items from said remote server to said user mobile electronic device, and limiting meal selections that may be made by a user to only those menu items that are available.

17. The improved meal ordering method of claim 13, further comprising the steps of communicating information regarding available menu items to said remote server, communicating said information regarding available menu items from said remote server to said user mobile electronic device, and limiting meal selections that may be made by a user to only those menu items that are available.

18. The improved meal ordering method of claim 14, further comprising the steps of communicating information regarding available menu items to said remote server, communicating said information regarding available menu items from said remote server to said user mobile electronic device, and limiting meal selections that may be made by a user to only those menu items that are available.

19. The improved meal ordering method of any of claims 11-18, further comprising the steps of uploading table wait times to said remote server from a restaurant, communicating said table wait times from said remote server to said mobile electronic device, and displaying said table wait times on said visual display of said user mobile electronic device.

20. The improved meal ordering method of any of claims 11-18, further comprising the steps of entering user's restaurant arrival time into said user mobile electronic device, communicating said user's restaurant arrival time to said remote server from said user mobile electronic device, and communicating said user's restaurant arrival time to a restaurant.
